(19) United States
(12) Patent Application Publication
(10) Pub. No.: US 2019/0092206 A1
(43) Pub. Date: Mar. 28, 2019

(54) TEMPERATURE-CONTROLLABLE DRINKS HOLDER

(71) Applicant: GENTHERM GMBH, Odelzhausen (DE)

(72) Inventors: Simon Rauch, Freising (DE); Johannes Grau, Friedberg (DE); Gabriel Manta, Augsburg (DE); Thomas Johansen, Kirchseeon (DE); Sven Watzke, Augsburg (DE)

(21) Appl. No.: 16/094,929

(22) PCT Filed: Mar. 16, 2017
(86) PCT No.: PCT/DE2017/000067

§ 371 Date: Oct. 19, 2018

(30) Foreign Application Priority Data
Apr. 22, 2016 (DE) 10 2016 004 911.1

(51) Int. Cl. B60N 3/10; F25B 21/04; A47J 36/24

(52) U.S. Cl. CPC B60N 3/104; A47J 36/24; F25B 21/04

(57) ABSTRACT

The invention relates to a temperature-controllable beverage holder (10), having a holding device (12) that is configured for holding a drinking vessel (54) and that provides a temperature control chamber (14) for the drinking vessel (54), a Peltier element (16) that is coupled to the temperature control chamber (14) in a heat-transmitting manner, a heat transport body (18) that is coupled to the Peltier element (16) in a heat-transmitting manner, and a fastening device (20) that is configured for fastening the Peltier element (16) and the heat transport body (18) to the holding device (12), wherein the fastening device (20) is configured for detachably fastening the Peltier element (16) and the heat transport body (18) to the holding device (12). The invention further relates to a dashboard (50) for a vehicle (100), and to a vehicle (100) having such a temperature-controllable beverage holder (10).

The invention relates to a temperature-controllable beverage holder, having a holding device that is configured for holding a drinking vessel and that provides a temperature control chamber for the drinking vessel, a Peltier element that is coupled to the temperature control chamber in a heat-transmitting manner, a heat transport body that is coupled to the Peltier element in a heat-transmitting manner, and a fastening device that is configured for fastening the Peltier element and the heat transport body to the holding device. The invention further relates to a dashboard for a vehicle, and a vehicle.

Temperature-controllable beverage holders are used in vehicles, for example, to heat or cool drinking fluids in drinking vessels, such as a can or a cup, to a certain drinking temperature in order to keep drinking fluids at a certain temperature level. Since the available space in the interior of a vehicle is limited, there is a need for devices that are suitable for heating as well as cooling, so that the vehicle occupants have the option to appropriately control the temperature of cold and hot beverages.

For carrying out these temperature control functions, the use of Peltier elements, which via a current reversal may be employed for heating as well as for cooling of drinking vessels, has become prevalent.

The Peltier element is generally coupled to a holding device in a heat-transmitting manner, the holding device allowing accommodation of a drinking vessel, for example a can or a cup, and providing a temperature control chamber for the drinking vessel. A heat flow or heat flux may thus be generated between the drinking vessel and the Peltier element.

Peltier elements have the property that during current flow, a first side of the Peltier element is always heated, and at the same time a second, typically oppositely situated side is cooled. For this reason, known devices for controlling the temperature of drinking vessels have a heat transport body that is coupled to the Peltier element in a heat-transmitting manner and that promotes the release of heat to the surroundings or the absorption of heat from the surroundings.

For this purpose, it has been necessary thus far to machine the heat transport body so that it, together with the Peltier element, can be fastened to the holding device. The machining of the heat transport body has included, for example, the removal of ribs and introduction of boreholes to allow screwing onto the holding device. These machining processes are very time-consuming, and thus have a significant influence on the manufacturing costs of such a temperature control device.

In the past, in addition to the screw connection the heat transport body has been nondetachably adhesively bonded to the holding device. This type of connection has the disadvantage that the Peltier element situated between the holding device and the heat transport body is subjected to nonuniform pressure during installation of the temperature control device, namely, during tightening of the individual screws. The resulting peak stresses may lead to damage or even destruction of the Peltier element. To reduce the risk of damage to the Peltier element during installation, special tools are used to allow low tightening torques to be achieved. However, this results in a further increase in the complexity and cost of production.

The object of the invention, therefore, is to at least partially overcome the disadvantages of the prior art.

The object is achieved with a temperature-controllable beverage holder of the type stated at the outset, wherein the fastening device is configured for detachably fastening lo the Peltier element and the heat transport body to the holding device. Due to the detachable connection, the need for adhesive bonding is eliminated, so that this production step is dispensed with and the production costs are lowered.

In one preferred embodiment of the temperature-controllable beverage holder according to the invention, the fastening device is configured for fastening the Peltier element and the heat transport body to the holding device under pretensioning. The pretensioning ensures stable and robust fastening of the Peltier element and the heat transport body to the holding device. A long-lasting temperature-controllable beverage holder is thus provided, in which no adhesive bonding is required in order to achieve high vibration resistance.

The temperature-controllable beverage holder according to the invention is further advantageously refined by situating the fastening device, at least in sections, to the side of the heat transport body when the Peltier element and the heat transport body are fastened to the holding device by means of the fastening device. The production costs may be reduced significantly when the need for penetrating the heat transport body is eliminated, so that the introduction of boreholes into the heat transport body is dispensed with. As a result of the fastening device being situated, at least in sections, to the side of the heat transport body when the Peltier element and the heat transport body are fastened to the holding device by means of the fastening device, the fastening takes place on the side of the heat transport body, so that no machining is necessary for achieving the fastening.

In another preferred embodiment, the fastening device of the temperature-controllable beverage holder according to the invention extends in sections along two sides of the heat transport body when the Peltier element and the heat transport body are fastened to the holding device by means of the fastening device. These two sides are preferably opposite sides of the heat transport body.

The holding device may have a one-part or multi-part design. The holding device is preferably made partially or completely of aluminum. Aluminum has excellent heat conduction properties and a low density, so that a comparatively high efficiency and low weight may be achieved by using aluminum.

In one preferred embodiment of the temperature-controllable beverage holder according to the invention, the fastening device has an elastically deformable design, at least in sections. The fastening device is preferably configured to elastically deform during the fastening of the Peltier element and the heat transport body to the holding device. The fastening device may thus be converted from a first undeformed state into a second elastically deformed state under stress, wherein due to the elastic deformation, the fastening device continually seeks to assume the first undeformed state. As a result of the elastic deformability of the fastening device, clamping or bracing of the heat transport body and the Peltier element against the holding device may be achieved. Such an elastically deformable fastening device is manufacturable at low cost, and allows uncomplicated, rapid installation. The elastically deformable design of the fastening device, at least in lo sections, thus results in a further reduction in production costs. In addition, the reversibility of the elastic deformation allows reuse or multiple use of the fastening device. Thus, for example, after removal which may be necessary due to required repairs or cleaning of the temperature-controllable beverage holder, the fastening device may be reused for fastening the Peltier element and the heat transport body to the holding device.

Alternatively or additionally, the fastening device has a plastically deformable design, at least in sections. The fastening device is preferably configured to plastically deform during the fastening of the Peltier element and the heat transport body to the holding device. Due to the irreversible plastic deformation during the fastening of the Peltier element and the heat transport body to the holding device, the situation may be prevented, for example, of unskilled persons removing the temperature-controllable beverage holder, and after making modifications or replacing components, re-assembling it. Consequently, there is increased operational reliability and reduced risk of inexpert modification of the temperature-controllable beverage holder.

The temperature-controllable beverage holder according to the invention is advantageously refined in that the fastening device includes a sheet, in particular a metal sheet. Sheets are available in large quantities and at low cost. By selecting a suitable thickness and shape of a sheet, the elastic and/or plastic deformability of sheets may be precisely set and adapted to the particular intended purpose. The desired shape of the sheet may be provided at low cost via various production processes, in particular forming production processes such as draw forming, pressure forming, bend forming, or shear forming. Sheets may also be cost-effectively modified by means of various separating processes and joining processes. The sheet preferably has a sheet thickness in a range of 0.25 mm to 0.75 mm. In another preferred embodiment, the sheet has a sheet thickness in a range of 0.4 mm to 0.6 mm, with a sheet thickness of approximately 0.5 mm being particularly preferred. The fastening device may thus be used as a spring sheet, which after fastening of the Peltier element and the heat transport body to the holding device exerts a tension force on the Peltier element and the heat transport body in the direction of the holding device, and thus secures the Peltier element and the heat transport body to the holding device.

In another advantageous embodiment of the temperature-controllable beverage holder according to the invention, the sheet includes two oppositely situated side sections that are joined together by a web section. The two oppositely situated side sections preferably extend in each case along one side of the heat transport body, with the web section extending along the side of the heat transport body facing away from the holding device. The web section preferably has a contact area that contacts the heat transport body and subjects the heat transport body to pressure when the Peltier element and the heat transport body are fastened to the holding device by means of the fastening device. The exertion of pressure results in bracing or clamping of the Peltier element and the heat transport body against the holding device. The fastening device preferably has a mirror-symmetrical design with respect to a plane of symmetry. A uniform distribution of tension may thus be achieved during the fastening of the Peltier element and the heat transport body to the holding device. As a result, peak tensions in the area of the Peltier element are avoided, thus significantly reducing the risk of damage to the Peltier element during installation of the temperature-controllable beverage holder. In this way it is also possible to achieve a homogeneous distribution of tension without the need to use a special tool.

The temperature-controllable beverage holder according to the invention is refined by orienting the two side sections essentially in parallel to one another. In particular, the sheet has an essentially U-shaped cross section. A space-saving design of the temperature-controllable beverage holder may be achieved due to the parallel orientation of the two side sections. An essentially U-shaped cross section is particularly suitable when the heat transport body has the basic shape of a cuboid. In this case, the fastening device may be situated in such a way that the fastening device surrounds the heat transport body on three sides. Reliable and robust fastening of the Peltier element and the heat transport body to the holding device may take place in this way.

In one particularly preferred embodiment of the temperature-controllable beverage holder according to the invention, the web section has a curved design, at least in sections. The curved web section, in comparison to uncurved sections, has increased elastic deformability, which results in increased flexibility of the fastening device. This is also accompanied by a reduction in the necessary installation forces, so that the web section, which is curved at least in sections, allows fastening of the Peltier element and the heat transport body to the holding device without tools.

In one advantageous refinement of the temperature-controllable beverage holder according to the invention, a convex curvature is provided between at least one side section and the web section. The convex curvature preferably extends over the entire width of the side section and/or over the entire width of the web section. It is particularly preferred for a convex curvature to be provided between each of the two side sections and the web section. Such a curvature offers several advantages. The curvature results in increased elastic deformability of the fastening device, and due to the increased flexibility thus facilitates installation of the temperature-controllable beverage holder without tools. Another significant advantage is that the exterior edges of the heat transport body, which are situated in the area of the transition from the particular side section to the web section of the sheet when the Peltier element and the heat transport body are fastened to the holding device by means of the fastening device, are protected from stress on account of the curvature or curvatures, thus preventing damage to the edges of the heat transport body. Protection from stress or overload on the edges is particularly important, especially for heat transport bodies that have a ribbed or lamellar structure in the exterior areas, since the edges of the heat transport body in these designs are at particular risk for damage.

In another preferred embodiment of the temperature-controllable beverage holder according to the invention, the fastening device has a strip, in particular a steel strip. Fastening the Peltier element and the heat transport body to the holding device by means of a strip is achievable with a particularly low expenditure of materials and installation effort. The strip is preferably subjected to tension when the Peltier element and the heat transport body are fastened to the holding device by means of the fastening device. The tensile stress on the strip results in robust and effective bracing of the Peltier element and the heat transport body against the holding device.

The fastening device preferably has mutually cooperating fixing means. The mutually cooperating fixing means are configured for fixing the fastening device. The fixing means are preferably configured for establishing a form-fit connection between the sheet of the fastening device and the holding device. Alternatively or additionally, the fixing means are configured for establishing a force-fit and/or integrally joined connection between the sheet of the fastening device and the holding device.

The temperature-controllable beverage holder according to the invention is further advantageously refined by enclosing the heat transport body, at least in sections, with thermal insulation. The thermal insulation limits the space in which heat can be released by the heat transport body or absorbed by the heat transport body. Inadvertent influencing of the temperature of the surroundings of the temperature-controllable beverage holder and/or impairment of the temperature control performance of the temperature-controllable beverage holder may be effectively avoided in this way. It is also preferred that the fixing means are enclosed by thermal insulation. Significant heat exchange with the surroundings can take place via a thermal bridge, even when comparatively small fixing means are used, so that the temperature is inadvertently influenced and/or the temperature control performance of the temperature-controllable beverage holder is impaired.

In another advantageous embodiment of the temperature-controllable beverage holder according to the invention, the mutually cooperating fixing means are configured for fixing the fastening device without tools. In this way, the fastening of the Peltier element and the heat transport body to the holding device may take place without tools, resulting in simplification of the installation process. Alternatively or additionally, the mutually cooperating fixing means are configured for fixing the fastening device in a reversibly releasable, nondestructive manner. Due to the reversibly releasable fixing, after removal the temperature-controllable beverage holder may be reassembled without the need for replacement parts. Repairs and cleaning may thus be carried out without the use of additional materials or parts.

In addition, a temperature-controllable beverage holder according to the invention is preferred in which the mutually cooperating fixing means include one or more pins and one or more through holes that correspond to the pins.

The mutually cooperating fixing means are situated in such a way that the one or more pins extend(s) through the one or more through holes when the fastening device is fixed to the holding device. Two through holes are preferably provided in each case on the side sections of the sheet of the fastening device. Four pins are preferably situated on the holding device, with two pins that are situated in parallel to one another and spaced apart from one another extending away from the holding device in a first direction, and with two pins that are situated in parallel to one another and spaced apart from one another extending away from the holding device in a second direction. The first direction is preferably opposite from the second direction. The pins and/or the through holes preferably have a square, rectangular, circular, or oval cross section. It is also preferred that the pins have tapering or a continuous cross-sectional reduction at their respective ends. This simplifies and speeds up installation of the fastening device. The pins are preferably designed as an integral part of the holding device. Alternatively, the pins are designed as separate parts that are subsequently joined to a section of the one-part or multi-part holding device.

In another advantageous embodiment of the temperature-controllable beverage holder according to the invention, the heat transport body has a plurality of ribs. The surface of the heat transport body is enlarged by providing ribs. The available surface for heat exchange has a significant effect on the thermal resistance from the heat transport body. The plurality of ribs thus significantly increases the ability of the heat transport body to release heat to the surroundings, and the ability of the heat transport body to absorb heat from the surroundings.

The temperature-controllable beverage holder according to the invention is further advantageously refined in that the Peltier element is situated between the holding device and the heat transport body when the Peltier element and the heat transport body are fastened to the holding device by means of the fastening device.

The object underlying the invention is also achieved by a dashboard for a vehicle, wherein the dashboard includes a temperature-controllable beverage holder according to one of the embodiments described above. With regard to the advantages of the dashboard according to the invention, reference is made to the advantages of the temperature-controllable beverage holder according to the invention.

The object underlying the invention is also achieved by a vehicle, wherein the vehicle includes a temperature-controllable beverage holder according to one of the embodiments described above or a dashboard according to the embodiment described above. With regard to the advantages of the vehicle according to the invention, reference is made to the advantages of the temperature-controllable beverage holder according to the invention.

Preferred embodiments of the invention are explained and described in greater detail below with reference to the appended drawings, which show the following:

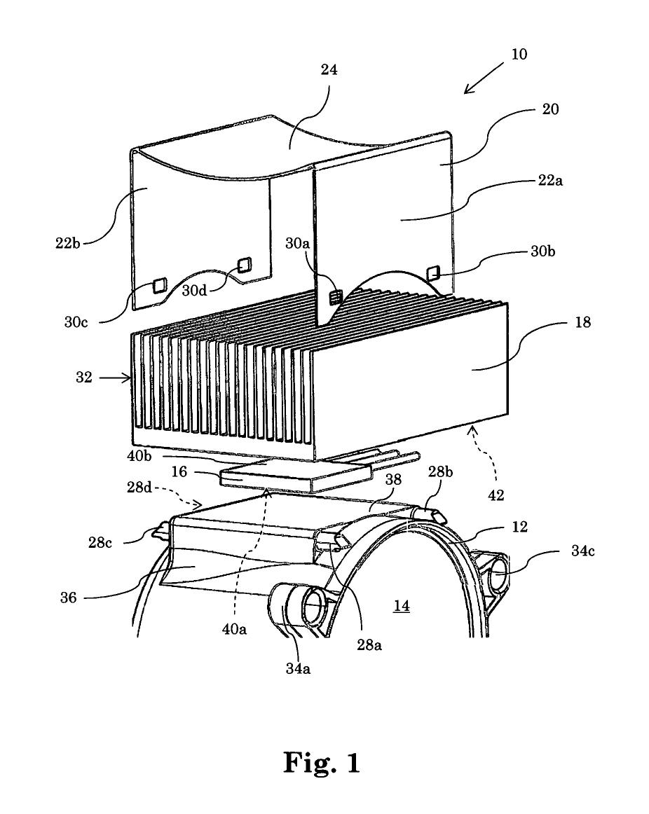

FIG. 1 shows one exemplary embodiment of the temperature-controllable beverage holder according to the invention in an exploded illustration;

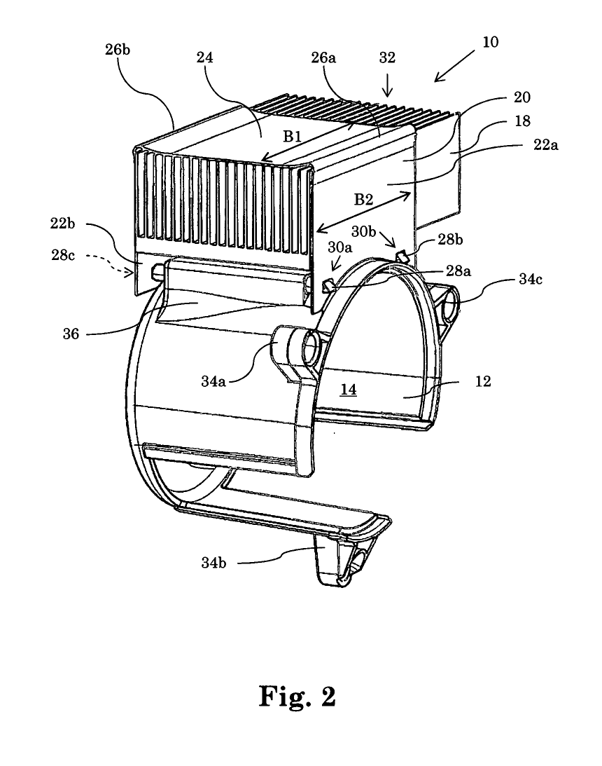

FIG. 2 shows another exemplary embodiment of the temperature-controllable beverage holder according to the invention in a perspective illustration; and

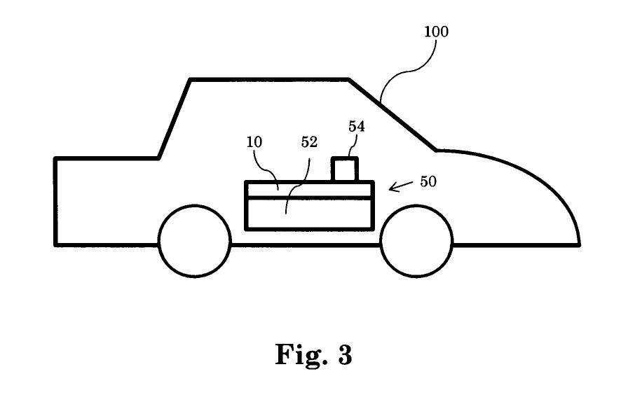

FIG. 3 shows one exemplary embodiment of the vehicle according to the invention together with a dashboard according to the invention.

According to FIG. 1, the temperature-controllable beverage holder 10 according to the invention has a holding device 12, a Peltier element 16, a heat transport body 18, and a fastening device 20.

The holding device 12 is configured for accommodating a drinking vessel. In addition, the holding device 12 provides a temperature control chamber 14 for the drinking vessel, which may be a can or a cup, for example. The drinking vessel may be heated or cooled inside the temperature control chamber 14. The temperature-controllable beverage holder 10 according to the invention thus allows the temperature of cold beverages and hot beverages to be controlled corresponding to their drinking temperature.

The holding device 12 also includes three mounting extensions 34a, 34c (the mounting extension 34b is not illustrated). The mounting extensions 34a, 34b, 34c have through holes that are used for fastening the holding device 12 to a center console of a dashboard of a motor vehicle. The holding device 12 has a one-part design, with an intermediate element 36 being situated on the holding body that forms the temperature control chamber 14. The intermediate element 36 and the holding body that forms the temperature control chamber 14 are an integral part of the holding device 12, and are made completely of aluminum.

A total of four fixing means 28a, 28b, 28c, 28d designed as pins are situated on the intermediate element 36. The pins 28a and 28b are situated in parallel to one another and spaced apart from one another, and extend away from the holding device 12 in a first direction. The pins 28c and 28d (concealed) are likewise situated in parallel to one another and spaced apart from one another, and extend away from the holding device 12 in a second direction. The first direction is opposite the second direction. The pins 28a, 28b, 28c, 28d have an oval cross section, and have tapering at their respective ends which simplifies and speeds up installation of the fastening device 20. The fixing means 28a, 28b, 28c, 28d designed as pins are provided as an integral part of the holding device 12. The intermediate element 38 [sic; 36] has a contact surface 38 that contacts a contact surface 40a of the Peltier element 16 when the Peltier element 16 and the heat transport body 18 are fastened to the holding device 12 by means of the fastening device 20.

The Peltier element 16 is coupled to the temperature control chamber 14 in a heat-transmitting manner, and is situated between the holding device 12 and the heat transport body 18 when the Peltier element 16 and the heat transport body 18 are fastened to the holding device 12 by means of the fastening device 20. The Peltier element 16 has a contact surface 40b situated opposite from the contact surface 40a. Depending on the current direction that is set, the contact surface 40a is heated and the contact surface 40b is cooled, or the contact surface 40a is cooled and the contact surface 40b is heated.

The heat transport body 18 is coupled to the contact surface 40b of the Peltier element 16 in a heat-transmitting manner via the contact surface 42. The heat transport body 18 has a plurality of ribs 32.

The surface of the heat transport body 18 is enlarged by the ribs 32. Due to the fact that the available surface for heat exchange significantly affects the thermal resistance from the heat transport body 18, the plurality of ribs 32 significantly increases the ability of the heat transport body 18 to release heat to the surroundings, and the ability of the heat transport body 18 to absorb heat from the surroundings.

The fastening device 20 has a sheet, and is configured for detachably fastening the Peltier element 16 and the heat transport body 18 to the holding device 12 under pretensioning. The sheet has two oppositely situated, parallel side sections 22a, 22b that are joined together by a web section 24. The two oppositely situated side sections 22a, 22b in each case extend along one side of the heat transport body 18. The fastening device 20 is thus situated to the side of the heat transport body 18 in sections when the Peltier element 16 and the heat transport body 18 are fastened to the holding device 12 by means of the fastening device 20.

The web section 24 extends along the side of the heat transport body 18 facing away from the holding device 12, and has a fully curved design between the two side sections 22a, 22b. As a result of the curved web section 24, the fastening device 20 has an elastically deformable design in sections, and for this purpose is configured to elastically deform when the Peltier element 16 and the heat transport body 18 are fastened to the holding device 12.

The web section 24 has a contact area that contacts the heat transport body 18 and subjects the transport body 18 to pressure when the Peltier element 16 and the heat transport body 18 are fastened to the holding device 12 by means of the fastening device 20.

The fastening device 20 has a total of four fixing means 30a, 30b, 30c, 30d that are designed as through holes. The through holes 30a, 30b, 30c, 30d have an essentially rectangular cross section.

The fixing means 28a, 28b, 28c, 28d designed as pins and the fixing means 30a, 30b, 30c, 30d designed as through holes cooperate with one another in order to fix the fastening device 20. The mutually cooperating fixing means 28a, 28b, 28c, 28d, 30a, 30b, 30c, 30d are situated in such a way that the pins extend through the through holes when the fastening device 20 is fixed. In addition, the mutually cooperating fixing means 28a, 28b, 28c, 28d, 30a, 30b, 30c, 30d are configured to allow the fastening device 20 to be fixed without tools in a reversibly releasable, nondestructive manner.

The temperature-controllable beverage holder 10 shown in FIG. 2 differs from the temperature-controllable beverage holder 10 shown in FIG. 1 by the design of the fastening device 20. The web section 24 of the sheet of the fastening device 20 does not have a completely curved design between the two side sections 22a, 22b, but, rather, has a flat, uncurved middle part.

A convex curvature 26a, 26b is provided in each case between the side sections 22a, 22b and the web section 24. The convex curvatures 26a, 26b extend over the entire width B2 of the side sections 22a, 22b and over the entire width B1 of the web section 24. The curvatures 26a, 26b result in increased elastic deformability of the fastening device 20, and due to the increased flexibility thus facilitate installation of the temperature-controllable beverage holder 10 without tools. In addition, the edges of the exterior ribs 32 of the heat transport body 18, situated in the area of the transition from the particular side section 22a, 22b to the web section 24 of the sheet, are protected from stress on account of the curvatures 26a, 26b, thus preventing damage to the edges.

According to FIG. 3, the vehicle 100 has a temperature-controllable beverage holder 10. The temperature-controllable beverage holder 10 is installed in a center console 52 of a dashboard 50. A drinking vessel 54 is situated in the holding device of the temperature-controllable beverage holder 10. The temperature-controllable beverage holder 10 has a design according to one of claims 1 to 15.

### LIST OF REFERENCE NUMERALS

10 temperature-controllable beverage holder
12 holding device
14 temperature control chamber
16 Peltier element
18 heat transport body
20 fastening device
22a, 22b side sections
24 web section
26a, 26b curvatures
28a, 28b, 28c, 28d fixing means
30a, 30b, 30c, 30d fixing means
32 ribs
34a, 34b, 34c mounting extensions
36 intermediate element
38 contact surface
40a, 40b contact surfaces
42 contact surface
50 dashboard
52 center console
54 drinking vessel
100 vehicle
B1 width
B2 width

1. A temperature-controllable beverage holder comprising:
a holding device that is configured for holding a drinking vessel and that provides a temperature control chamber for the drinking vessel;
a Peltier element that is coupled to the temperature control chamber in a heat-transmitting manner;
a heat transport body that is coupled to the Peltier element in a heat-transmitting manner; and
a fastening device that is configured for fastening the Peltier element and the heat transport body to the holding device,
wherein the fastening device is configured for detachably fastening the Peltier element and the heat transport body to the holding device.

2. The temperature-controllable beverage holder according to claim 1, wherein the fastening device is configured for fastening the Peltier element and the heat transport body to the holding device under pretensioning.

3. The temperature-controllable beverage holder according to claim 1, wherein the fastening device, at least in sections, is fastened to the side of the heat transport body when the Peltier element and the heat transport body are fastened to the holding device by means of the fastening device.

4. The temperature-controllable beverage holder according to claim 1, wherein the fastening device has an elastically and/or plastically deformable design, at least in sections, and is configured to elastically and/or plastically deform during the fastening of the Peltier element and the heat transport body to the holding device.

5. The temperature-controllable beverage holder according to claim 1, wherein the fastening device includes a sheet.

6. The temperature-controllable beverage holder according to claim 5, wherein the sheet includes two oppositely situated side sections that are joined together by a web section.

7. The temperature-controllable beverage holder according to claim 6, wherein the two side sections are oriented essentially in parallel to one another.

8. The temperature-controllable beverage holder according to claim 6, wherein the web section has a curved design, at least in sections.

9. The temperature-controllable beverage holder according to claim 6, wherein a convex curvature is provided between at least one side section and the web section, and extends over the entire width of the side section and/or over the entire width of the web section.

10. The temperature-controllable beverage holder according to claim 1, wherein the fastening device has a strip.

11. The temperature-controllable beverage holder according to one claim 1, wherein the fastening device has mutually cooperating fixing means that are configured for fixing the fastening device.

12. The temperature-controllable beverage holder according to claim 11, wherein the mutually cooperating fixing means are configured for fixing the fastening device without tools and/or in a reversibly releasable, nondestructive manner.

13. The temperature-controllable beverage holder according to claim 11, wherein the mutually cooperating fixing means include one or more pins and one or more through holes that correspond to the pins, wherein the mutually cooperating fixing means are situated in such a way that the one or more pins extend(s) through the one or more through holes when the fastening device is fixed.

14. The temperature-controllable beverage holder according to one claim 1, wherein the heat transport body has a plurality of ribs.

15. The temperature-controllable beverage holder according to claim 1, wherein the Peltier element is situated between the holding device and the heat transport body when the Peltier element and the heat transport body are fastened to the holding device by means of the fastening device.

16. A dashboard for a vehicle, wherein the dashboard includes a temperature-controllable beverage holder according to claim 1.

17. A vehicle, wherein the vehicle includes a temperature-controllable beverage holder according to claim 1.

18. A vehicle, wherein the vehicle includes a dashboard according to claim 16.
